(19) United States
(12) Patent Application Publication
(10) Pub. No.: US 2023/0083714 A1
(43) Pub. Date: Mar. 16, 2023

(54) OPTICAL GLASS

(71) Applicant: NIPPON ELECTRIC GLASS CO., LTD., Otsu-shi, Shiga (JP)

(72) Inventors: Satoko KONOSHITA, Otsu-shi (JP); Koichi YABUUCHI, Otsu-shi (JP)

(21) Appl. No.: 17/798,119

(22) PCT Filed: Mar. 29, 2021
(86) PCT No.: PCT/JP2021/013303

§ 371 Date: Aug. 8, 2022

(30) Foreign Application Priority Data
Apr. 6, 2020 (JP) 2020-068281
Dec. 18, 2020 (JP) 2020-210332
Mar. 3, 2021 (JP) 2021-033317

(51) Int. Cl. C03C 3/068; C03C 3/062; C03C 3/097; F21V 8/00; C03B 19/02

(52) U.S. Cl. CPC C03C 3/068; C03C 3/062; C03C 3/097; G02B 6/0065; C03B 19/02

(57) ABSTRACT

Provided is an optical glass that contains TiO₂ and/or Nb₂O₅ as components of a glass composition, achieves a high light transmittance, and has excellent mass productivity. An optical glass contains TiO₂ and Nb₂O₅ in a total amount of 20% by mole or more as components of a glass composition and has a basicity of 12 or more.

### TECHNICAL FIELD

The present invention relates to optical glasses for use as light guide plates of wearable image display devices and so on.

### BACKGROUND ART

Glass plates are used as components of wearable image display devices, including projector-equipped eyeglasses, an eyeglass- or goggle-mounted display, a virtual reality (VR) or augmented reality (AR) display device or a virtual image display device. For example, such a glass plate functions as a see-through light guide plate to enable the user to watch images displayed on the glass plate while looking at the view through the glass plate. Alternatively, such a glass plate enables realization of a 3D display using a technique for projecting different images on the left and right eyeglasses or realization of a virtual reality space using a technique for focusing images on the user's retina with the use of eye lens. These glass plates are required to have a high refractive index in terms of wide angle display of images, high brightness and high contrast, enhancement in light guide properties, and so on (see, for example, Patent Literature 1).

### CITATION LIST

### Patent Literature

### [PTL 1]

JP-A-2017-32673

### [PTL 2]

JP-B2-6517411

### SUMMARY OF INVENTION

### Technical Problem

In order to increase the refractive index of glass, it is effective to contain, in the glass, TiO₂ or Nb₂O₅ which are components contributing to a high refractive index. However, when TiO₂ or Nb₂O₅ is contained in the glass, the light transmittance of the glass tends to decrease. To solve this problem, there is proposed a method of subjecting glass after being melted and molded into shape to prolonged annealing treatment to increase the light transmittance of the glass (see, for example, Patent Literature 2). However, this method has a problem that it takes much cost and time.

In view of the foregoing, the present invention has an object of providing an optical glass that contains TiO₂ and/or Nb₂O₅ as components of a glass composition, achieves a high light transmittance, and has excellent mass productivity.

### Solution to Problem

The inventors conducted intensive studies and, as a result, found that when an optical glass containing TiO₂ and/or Nb₂O₅ as high-refractive index components in a specific amount or more is given a ligand field allowing Ti ions and/or Nb ions in the glass to be stably present in a high valence state, it can easily achieve high light transmittance properties.

Specifically, an optical glass according to the present invention contains TiO₂ and Nb₂O₅ in a total amount of 20% by mole or more as components of a glass composition and has a basicity of 12 or more. Thus, Ti ions and Nb ions in the glass can be present stably in a high valence state enabling lower absorption. As a result, the optical glass can achieve high light transmittance properties without having to be subjected to prolonged annealing treatment.

The optical glass according to the present invention preferably contains, in terms of % by mole, 8 to less than 40% TiO₂ and 1 to 11% Nb₂O₅.

The optical glass according to the present invention preferably has a refractive index nd of 1.8 to 2.3.

The optical glass according to the present invention preferably has an Abbe's number (νd) of 20 to 35.

The optical glass according to the present invention preferably has, with a thickness of 10 mm, an internal transmittance of 80% or more at a wavelength of 450 nm.

An optical glass according to another aspect of the present invention contains TiO₂ and Nb₂O₅ in a total amount of 20% by mole or more and 10 to 40% (B₂O₃+La₂O₃+ZnO)—(SiO₂+Y₂O₃+ZrO₂) as components of a glass composition, wherein a number of bubbles and foreign substances present in an interior of the optical glass is one or less per cm³.

The optical glass according to the present invention preferably contains, in terms of % by mole, 10 to 30% B₂O₃, 3% or more SiO₂, 0 to 5% RO (where R represents at least one selected from Mg, Ca, Sr, and Ba), 0 to 5% Ta₂O₅, 10 to 50% Ln₂O₃ (where Ln represents at least one selected from La, Gd, Y, and Yb), 0 to 1% ZnO, 0 to 1% Al₂O₃, and 0 to 0.2% WO₃.

In the optical glass according to the present invention, when the optical glass is thermally treated in a range of plus or minus 200° C. from a glass transition point for 72 hours, an amount of change in internal transmittance of the optical glass with a thickness of 10 mm at a wavelength of 450 nm is preferably less than 10%. The optical glass according to the present invention can achieve high transmittance properties with or without prolonged annealing treatment. In other words, the optical glass has a feature that the amount of change in internal transmittance thereof when subjected to prolonged annealing treatment is small.

An optical glass plate according to the present invention is made of any one of the above-described optical glasses.

The optical glass plate according to the present invention preferably has a thickness of 0.01 to 5 mm.

A light guide plate according to the present invention is formed of any one of the above-described optical glass plates.

The light guide plate according to the present invention is preferably used in a wearable image display device selected from among projector-equipped eyeglasses, an eyeglass- or goggle-mounted display, a virtual reality (VR) or augmented reality (AR) display device, and a virtual image display device.

A wearable image display device according to the present invention includes any one of the above-described light guide plates.

A method for producing an optical glass according to the present invention is a method for producing any one of the above-described optical glasses, includes the step of melting a raw material to obtain molten glass and then cooling the molten glass to obtain a molded body, and avoids subjecting the molded body to thermal treatment in a range of plus or minus 200° C. from a glass transition point of the molded body for 48 hours or more. As described previously, the optical glass according to the present invention can achieve high transmittance properties with or without prolonged annealing treatment. Therefore, the production method according to the present invention can skip a prolonged thermal treatment step of subjecting the molded body to thermal treatment, for example, in a range of plus or minus 200° C. from the glass transition point of the molded body for 48 hours or more and, thus, has a feature of excellent mass productivity.

In the method for producing an optical glass according to the present invention, a temperature during the melting of the raw material is preferably 1400° C. or lower. Thus, a component (such as Pt) of a melting container is difficult to elute off in glass melt during the melting, which makes it possible to increase the light transmittance of the obtained optical glass.

### Advantageous Effects of Invention

The present invention enables provision of an optical glass that contains TiO₂ and/or Nb₂O₅ as components of a glass composition, achieves a high light transmittance, and has excellent mass productivity.

### BRIEF DESCRIPTION OF DRAWINGS

FIG. 1 shows a graph on which the relationship between the basicity and the amount of change in internal transmittance for glass samples obtained in examples is plotted.

### DESCRIPTION OF EMBODIMENTS

An optical glass according to the present invention contains as a component of a glass composition at least one selected from TiO₂ and Nb₂O₅. A description will be given below of preferred contents and so on of these components. In the following description of the contents of components, % refers to “% by mole” unless otherwise stated.

TiO₂ and Nb₂O₅ are components that significantly increase the refractive index of glass. However, if the content of these components is too large, the glass material is difficult to vitrify or the light transmittance of the glass in the visible range is likely to decrease. Therefore, the lower limit of the content of TiO₂+Nb₂O₅ is preferably not less than 20%, more preferably not less than 25%, still more preferably not less than 27%, yet still more preferably not less than 29%, and particularly preferably not less than 30%, and the upper limit thereof is preferably not more than 40%, more preferably not more than 38%, and particularly preferably not more than 35%. The lower limit of the content of TiO₂ is preferably not less than 8%, more preferably not less than 10%, still more preferably not less than 15%, yet still more preferably not less than 18%, even still more preferably not less than 22%, and particularly preferably not less than 23%, and the upper limit thereof is preferably less than 40%, more preferably not more than 35%, still more preferably not more than 32%, and particularly preferably not more than 29%. The lower limit of the content of Nb₂O₅ is preferably not less than 1%, more preferably not less than 2%, still more preferably not less than 2.5%, and particularly preferably not less than 3%, and the upper limit thereof is preferably not more than 11%, more preferably not more than 8%, still more preferably not more than 6%, and particularly preferably not more than 5%. In the present invention, “x+y+ . . . ” means the total content of x, y, . . . which are components.

In order to obtain a glass having a high refractive index and an excellent transmittance in the visible range in the present invention, it is preferred to suitably control the ratio between TiO₂ and Nb₂O₅. Specifically, TiO₂/Nb₂O₅ is, in terms of molar ratio, preferably 3 or more, more preferably 4 or more, and particularly preferably 5 or more. The upper limit of the above ratio is not particularly limited, but it is actually less than 40 and preferably not more than 30.

The optical glass according to the present invention may contain, aside from TiO₂ and Nb₂O₅, the following components.

B₂O₃ is a component that contributes particularly to the stability of vitrification for a glass containing TiO₂ or Nb₂O₅. Particularly, when the refractive index nd is as high as 1.9 or more, the vitrification tends to be unstable. However, when the glass contains B₂O₃ in an appropriate amount, the stability of vitrification can be increased. The lower limit of the content of B₂O₃ is preferably not less than 10%, more preferably not less than 14%, still more preferably not less than 15%, yet still more preferably not less than 16%, and particularly preferably not less than 18%, and the upper limit thereof is preferably not more than 28%, more preferably not more than 25%, still more preferably not more than 23%, yet still more preferably not more than 22%, and particularly preferably not more than 21%. If the content of B₂O₃ is too small, the above effect is difficult to achieve. On the other hand, if the content of B₂O₃ is too large, the basicity and the refractive index tend to decrease. Particularly in the present invention, by containing B₂O₃ in the glass as well as increasing the basicity of the glass, the glass can achieve excellent mass productivity and high transmittance properties.

SiO₂ is a glass network component and a component that increases the stability of vitrification and the chemical durability. However, if its content is too large, the melting temperature becomes excessively high. As a result, Nb and Ti are likely to be reduced, which makes it likely that the internal transmittance decreases. In addition, the refractive index tends to decrease. The lower limit of the content of SiO₂ is preferably not less than 3%, more preferably not less than 5%, still more preferably not less than 8%, yet still more preferably not less than 9%, and particularly preferably not less than 10%, and the upper limit thereof is preferably not more than 25%, more preferably not more than 22%, still more preferably not more than 21%, yet still more preferably not more than 20%, even still more preferably not more than 19%, and particularly preferably not more than 18%.

In order to increase the stability of vitrification to increase the mass productivity, it is preferred to suitably control the ratio between SiO₂ and B₂O₃. Specifically, B₂O₃/SiO₂ is, in terms of molar ratio, preferably not less than 0.5, more preferably not less than 0.6, particularly preferably not less than 0.8, preferably not more than 10, and particularly preferably not more than 8. In the present invention, “x/y” means the value obtained by dividing the content of x by the content of y.

In the present invention, the content of Si⁴⁺+B³⁺ is, in terms of % by cation, preferably 30% or more, more preferably 32% or more, and particularly preferably 33% or more. Thus, the stability of vitrification can be increased. The upper limit of the content of Si⁴⁺+B³⁺ is not particularly limited. However, if the content thereof is too large, there is a tendency for the refractive index to decrease and for the melting temperature to increase. Therefore, the upper limit of the content thereof is preferably not more than 50%, more preferably not more than 45%, and particularly preferably not more than 40%.

An alkaline-earth component RO (where R is at least one selected from Mg, Ca, Sr, and Ba) is a component that stabilizes vitrification. If its content is too large, there is a tendency for the refractive index to decrease and for the liquidus temperature to increase. Particularly as for BaO, if its content is large, there is a tendency for the density of the glass to be large and thus for the weight of an optical element made of the optical glass according to the present invention to be large. Therefore, this case is not preferred particularly for use in a wearable image displace device and the like. Hence, the content of RO is preferably 5% or less, more preferably 2% or less, still more preferably 1% or less, and particularly preferably 0.5% or less. The content of each of MgO, CaO, SrO, and BaO and the preferred range of total contents of two or three selected from these components are also preferably the same as above.

Ta₂O₅ is a component that increases the refractive index. However, if its content is too large, the glass is likely to cause phase separation and devitrification. In addition, Ta₂O₅ is a rare and expensive component and, therefore, a large content thereof makes the cost of a raw material batch high. In view of these circumstances, the content of Ta₂O₅ is preferably 5% or less, more preferably 3% or less, still more preferably 1% or less, and the glass is particularly preferably free of Ta₂O₅.

La₂O₃ is a component that significantly increases the refractive index and increases the stability of vitrification. The lower limit of the content of La₂O₃ is preferably not less than 10%, more preferably not less than 14%, still more preferably not less than 19%, yet still more preferably not less than 20%, even still more preferably not less than 21%, and particularly preferably not less than 21.5%, and the upper limit thereof is preferably not more than 35%, more preferably not more than 30%, still more preferably not more than 28%, yet still more preferably not more than 26%, even still more preferably not more than 24%, and particularly preferably not more than 23.5%. If the content of La₂O₃ is too small, the above effects are difficult to achieve. On the other hand, if the content of La₂O₃ is too large, the glass tends to decrease the resistance to devitrification and thus have a poor mass productivity.

Gd₂O₃ is also a component that increases the refractive index and increases the stability of vitrification. The lower limit of the content of Gd₂O₃ is preferably not less than 1%, more preferably not less than 2%, and particularly preferably not less than 3%, and the upper limit thereof is preferably not more than 10%, more preferably not more than 7%, and particularly preferably not more than 5%.

Y₂O₃ is also a component that increases the refractive index and the chemical durability, but an excessively large content thereof tends to make the melting temperature extremely high and destabilize the vitrification. Therefore, the lower limit of the content of Y₂O₃ is preferably not less than 0%, more preferably not less than 0.1%, and particularly preferably not less than 0.5%, and the upper limit thereof is preferably not more than 8%, more preferably not more than 7%, still more preferably not more than 5%, yet still more preferably less than 4%, and particularly preferably not more than 2.5%.

Yb₂O₃ is also a component that increases the refractive index. However, if its content is too large, the glass is likely to cause devitrification and striae. Therefore, the content of Yb₂O₃ is preferably 10% or less, more preferably 8% or less, still more preferably 5% or less, yet still more preferably 3% or less, and particularly preferably 1% or less.

The content of Ln₂O₃ (where Ln is at least one selected from La, Gd, Y, and Yb) is preferably 11% or more, more preferably 15% or more, still more preferably 20% or more, and particularly preferably 22% or more. Thus, it is possible to increase the basicity of the glass and increase the refractive index and the light transmittance in the visible range. The upper limit of the content of Ln₂O₃ is not particularly limited. However, if the content is too large, the glass is likely to devitrify. Therefore, the upper limit thereof is preferably not more than 50%, more preferably not more than 40%, and particularly preferably not more than 30%.

In order to obtain a glass having a high refractive index and an excellent stability of vitrification in the present invention, it is preferred to suitably control the ratio between the total content of SiO₂ and B₂O₃ and the content of Ln₂O₃. Specifically, the lower limit of (SiO₂+B₂O₃)/Ln₂O₃ is preferably not less than 0.5, more preferably not less than 0.8, and particularly preferably not less than 1, and the upper limit thereof is preferably not more than 2, more preferably not more than 1.6, and particularly preferably not more than 1.4.

ZnO is a component that promotes the solubility (solubility of a raw material) in a composition system of the present invention. However, ZnO is a component that if its content is large, this makes the glass difficult to achieve high refractive index properties, promotes devitrification, and decreases the acid resistance. Therefore, it is preferred that the content of ZnO is small. Specifically, the content of ZnO is preferably 1% or less, more preferably 0.5% or less, and still more preferably less than 0.1%, and the glass is particularly preferably free of ZnO.

Al₂O₃ is a component that increases the water resistance. However, if its content is too large, the glass is likely to devitrify. Therefore, the content of Al₂O₃ is preferably 1% or less and more preferably 0.5% or less, and the glass is particularly preferably free of Al₂O₃.

WO₃ is a component that increases the refractive index, but absorbs light in the visible range to decrease the light transmittance. Therefore, the content of WO₃ is preferably 0.2% or less and more preferably 0.1% or less, and the glass is particularly preferably free of WO₃.

ZrO₂ is a component that increases the refractive index and the chemical durability. However, if its content is too large, the melting temperature tends to become excessively high. The lower limit of the content of ZrO₂ is preferably not less than 0%, more preferably more than 0%, still more preferably not less than 1%, yet still more preferably not less than 3%, even still more preferably not less than 4%, and particularly preferably not less than 5%, and the upper limit thereof is preferably not more than 15%, more preferably not more than 12%, still more preferably not more than 10%, yet still more preferably not more than 9%, and particularly preferably not more than 8%. If the content of ZrO₂ is too large, the glass is likely to devitrify.

In order to obtain a glass having a high refractive index and an excellent transmittance in the visible range in the present invention, it is preferred to suitably control the ratio among TiO₂, Nb₂O₅, and ZrO₂. Specifically, the lower limit of Nb₂O₅/(TiO₂+Nb₂O₅+ZrO₂) is, in terms of molar ratio, preferably not less than 0.05, more preferably not less than 0.06, and particularly preferably not less than 0.8, and the upper limit thereof is preferably not more than 0.2, more preferably not more than 0.15, and particularly preferably not more than 0.13.

In order to obtain a glass having an excellent transmittance in the visible range in the present invention, it is preferred to suitably control the total content of TiO₂, Nb₂O₅, and WO₃. Specifically, the content of TiO₂+Nb₂O₅+WO₃ is preferably 41% or less, more preferably 38% or less, and particularly preferably 35% or less. However, if the content of these components is too small, the glass is less likely to achieve desired high refractive index properties. Therefore, the lower limit of the content of TiO₂+Nb₂O₅+WO₃ is preferably not less than 20%.

In order to obtain a glass having a high refractive index and an excellent transmittance in the visible range in the present invention, it is preferred to suitably control the ratio among TiO₂, Nb₂O₅, and WO₃. Specifically, the lower limit of Nb₂O₅/(TiO₂+Nb₂O₅+WO₃) is, in terms of molar ratio, preferably not less than 0.05, more preferably not less than 0.07, and particularly preferably not less than 0.08, and the upper limit thereof is preferably not more than 0.3, more preferably not more than 0.25, and particularly preferably not more than 0.2.

In order to obtain a glass having a good solubility and an excellent quality in the present invention, it is preferred to suitably control the total content of B₂O₃, La₂O₃, and ZnO. These components can promote initial formation of melt and particularly increase the solubility at low temperatures. However, if the glass contains these components too much, the glass is less likely to achieve high refractive index properties. In view of these circumstances, the lower limit of B₂O₃+La₂O₃+ZnO is preferably not less than 35%, more preferably not less than 38%, and particularly preferably not less than 41%, and the upper limit thereof is preferably not more than 50%, more preferably not more than 48%, and particularly preferably not more than 46.5%.

In order to obtain a glass having a good solubility and an excellent quality in the present invention, it is preferred to suitably control the total content of SiO₂, Y₂O₃, and ZrO₂. These components are poorly soluble. Therefore, if the glass contains these component too much, the formation of melt tends to be impaired and, particularly, the solubility at low temperatures tends to decrease. Specifically, the lower limit of SiO₂+Y₂O₃+ZrO₂ is preferably not less than 10%, more preferably not less than 11%, and particularly preferably not less than 12%, and the upper limit thereof is preferably not more than 25%, more preferably not more than 22%, and particularly preferably not more than 19.5%.

In order to obtain a glass having a good solubility and an excellent quality in the present invention, it is preferred to suitably control the difference between the total content of B₂O₃, La₂O₃, and ZnO and the total content of SiO₂, Y₂O₃, and ZrO₂. Specifically, the lower limit of (B₂O₃+La₂O₃+ZnO)—(SiO₂+Y₂O₃+ZrO₂) is preferably not less than 10%, more preferably not less than 15%, still more preferably not less than 20%, and particularly preferably not less than 25%, and the upper limit thereof is preferably not more than 40%, more preferably not more than 35%, and particularly preferably not more than 30%.

By suitably controlling the content of B₂O₃+La₂O₃+ZnO, the content of SiO₂+Y₂O₃+ZrO₂ or the difference between these contents as described above, the solubility can be increased and, thus, internal defects, such as bubbles and foreign substances, in the optical glass can be reduced. The number of bubbles and foreign substances present in the interior of the optical glass is preferably 1 or less per cm³ or less, more preferably 0.5 or less per cm³, still more preferably 0.3 or less per cm³, and particularly preferably 0.2 or less per cm³.

In order to increase the refractive index and the light transmittance in the visible range and improve the stability of vitrification in the present invention, it is preferred to suitably control the ratio between Y₂O₃ and Ln₂O₃. Specifically, the lower limit of Y₂O₃/Ln₂O₃ is preferably not less than 0, more preferably not less than 0.005, and particularly preferably not less than 0.01, and the upper limit thereof is preferably not more than 0.3, more preferably not more than 0.25, and particularly preferably not more than 0.2.

In order to increase the refractive index and the light transmittance in the visible range and improve the stability of vitrification in the present invention, it is preferred to suitably control the ratio between Gd₂O₃ and Ln₂O₃. Specifically, the lower limit of Gd₂O₃/Ln₂O₃ is preferably not less than 0.05 and particularly preferably not less than 0.1, and the upper limit thereof is preferably not more than 0.25 and particularly preferably not more than 0.2.

In order to increase the refractive index and the light transmittance in the visible range and improve the stability of vitrification in the present invention, it is preferred to suitably control the ratio between the total content of TiO₂ and B₂O₃ and the total content of Nb₂O₅ and WO₃. Specifically, the lower limit of (TiO₂+B₂O₃)/(Nb₂O₅+WO₃) is preferably not less than 5, more preferably not less than 6, and particularly preferably not less than 8, and the upper limit thereof is preferably not more than 30, more preferably not more than 20, and particularly preferably not more than 15.

Li₂O, Na₂O, and K₂O are components that decrease the softening point, but an excessively large content of them makes it likely that the glass devitrifies. Therefore, the content of each of these components is preferably 10% or less, more preferably 5% or less, and still more preferably 1% or less, and the glass is particularly preferably free of these components. Furthermore, when the glass contains two or more of Li₂O, Na₂O, and K₂O, the total content of them is preferably 10% or less, more preferably 5% or less, and still more preferably 1% or less, and the glass is particularly preferably free of these components.

As components (such as As₂O₃), Pb components (such as PbO), and fluorine components (such as F₂) have a large effect on the environment and, therefore, the glass is preferably substantially free of these components. Bi₂O₃ and TeO₂ are coloring components to make a decrease in transmittance in the visible range likely and, therefore, the glass is preferably substantially free of these components. The term “substantially free of” herein means to deliberately avoid these components being contained as raw materials in the glass and does not mean to exclude even incorporation of unavoidable impurities. Objectively, this means that the content of each of these components is less than 0.1%.

Pt, Rh, and Fe₂O₃ are coloring components to make a decrease in transmittance in the visible range likely and, therefore, the content of them is preferably small. Specifically, the content of Pt is preferably 10 ppm or less and particularly preferably 5 ppm or less, the content of Rh is preferably 0.1 ppm or less and particularly preferably 0.01 ppm or less, and the content of Fe₂O₃ is preferably 1 ppm or less and particularly preferably 0.5 ppm or less. From the viewpoint of reducing coloration, the smaller the content of Pt, the better. However, this requires to lower the melting temperature, resulting in ease of decrease in solubility. Therefore, considering the solubility, the lower limit of the content of Pt is preferably not less than 0.1 ppm and particularly preferably not less than 0.5 ppm.

The optical glass according to the present invention may contain a clarifying component Cl, CeO₂, SO₂, Sb₂O₃ or SnO₂ in an amount of 0.1% or less.

In the optical glass according to the present invention, the glass basicity defined as ((the sum of number of moles of oxygen atoms)/(the sum of field strengths of cations (cation field strengths)))×100 is preferably 12 or more, more preferably 12.5 or more, still more preferably 13.3 or more, yet still more preferably 13.5 or more, and particularly preferably 14 or more. The “field strength (hereinafter, referred to as F.S.)” in the present invention can be determined by the following formula.

F.S.=Z/r² (where Z represents ion valence and r represents ionic radius (angstrom))

The numerical values of Z and r used in the present invention are values in Table 1. The values of r refer to those described in “Handbook of Chemistry, Pure Chemistry, 2nd ed. (published by Maruzen Publishing Co., Ltd. in 1975)” and so on. However, as for ionic radii of B³⁺ and P⁵⁺, 0.315 is adopted as a value when these ions are assumed to take on a tetrahedral structure together with oxygen ions in the glass (specifically, they take on a tetrahedral structure in a manner that four 02-ions are located around a B³⁺ ion or a P⁵⁺ ion)

For example, when the composition is composed of, in terms of % by mole, 15% SiO₂, 20% B₂O₃, 30% TiO₂, 5% Nb₂O₅, and 30% La₂O₃, its basicity can be calculated in the following manner.

First, the sum of F.S. of cations can be calculated as below:

F.S. per mole of Si⁴⁺ is Z(Si⁴⁺)/r(Si⁴⁺)²=4/(0.4)²=25.00;
F.S. per mole of B³⁺ is Z(B³⁺)/r(B³⁺)²=3/(0.315)²=30.23;
F.S. per mole of Ti⁴⁺ is Z(Ti⁴⁺)/r(Ti⁴⁺)²=4/(0.75)²=7.11;
F.S. per mole of Nb⁵⁺ is Z(Nb⁵⁺)/r(Nb⁵⁺)²=5/(0.78)²=8.22;
F.S. per mole of La³⁺ is Z(La³⁺)/r(La³⁺)=3/(1.32)²=1.72; and
the sum of the products of F.S. and the number of moles for all these types of ions is 25.00×15+30.23×2×20+7.11×30+8.22×2×5+1.72×2×30=1982.9.

Furthermore, regarding the number of oxygen atoms contained per mole of the glass, the number of oxygen atoms derived from SiO₂ is 15×2, the number of oxygen atoms derived from B₂O₃ is 3×20, the number of oxygen atoms derived from TiO₂ is 2×30, the number of oxygen atoms derived from Nb₂O₅ is 5×5, the number of oxygen atoms derived from La₂O₃ is 3×30, and the sum of these number of oxygen atoms is 265.

Based on the above, the basicity is (265/1982.9)×100≅13.4.

TABLE 1

| | Z | r |
|---|---|---|
| Si⁴⁺ | 4 | 0.4 |
| Al³⁺ | 3 | 0.53 |
| B³⁺ | 3 | 0.315 |
| Mg²⁺ | 2 | 0.86 |
| Ca²⁺ | 2 | 1.14 |
| Sr²⁺ | 2 | 1.39 |
| Ba²⁺ | 2 | 1.5 |
| Zn²⁺ | 2 | 0.89 |
| Li⁺ | 1 | 0.88 |
| Na⁺ | 1 | 1.16 |
| K⁺ | 1 | 1.52 |
| Ti⁴⁺ | 4 | 0.75 |
| Zr⁴⁺ | 4 | 0.86 |
| Nb⁵⁺ | 5 | 0.78 |
| La³⁺ | 3 | 1.32 |
| Gd³⁺ | 3 | 1.08 |
| Y³⁺ | 3 | 1.03 |
| Yb³⁺ | 3 | 0.86 |
| Ta⁵⁺ | 5 | 0.83 |
| W⁶⁺ | 6 | 0.72 |
| Bi³⁺ | 3 | 0.86 |
| Sb³⁺ | 3 | 0.94 |
| P⁵⁺ | 5 | 0.315 |
| Pt⁴⁺ | 4 | 0.77 |
| Ce⁴⁺ | 4 | 0.94 |
| S⁴⁺ | 4 | 0.51 |
| Sn⁴⁺ | 4 | 0.83 |
| Te⁴⁺ | 4 | 0.66 |
| As³⁺ | 3 | 0.69 |
| Pb²⁺ | 2 | 0.92 |

The basicity is an index indicating how strongly electrons and oxygen are trapped by cations. As the basicity increases, the strength of trapping of electrons and oxygen by cations becomes lower, which means that electrons and oxygen are more movable in the glass. When the glass is designed to make the basicity high, electrons or oxygen can be easily placed around a Ti ion or a Nb ion. As a result, Ti ions and Nb ions in the glass can be present stably in a high valence state (Ti⁴⁺ and Nb⁵⁺) enabling lower absorption and, thus, the optical glass can achieve high light transmittance properties. If the strength of trapping of electrons or oxygen by cations is too low, vitrification tends to be unstable and the chemical durability tends to decrease. Therefore, the basicity is preferably not more than 16 and particularly preferably not more than 15.

As for a glass having a high refractive index, specifically, a refractive index nd of 1.9 or more, coloration due to Ti⁴⁺ tends to significantly appear as compared to that due to Nb⁵⁺. Particularly, when the cation ratio Ti⁴⁺/Nb⁵⁺ is 2.1 or more, 2.5 or more, and 3 or more, the above tendency is strong. Even in this case, by making the basicity high as described above, electrons or oxygen can be placed around Ti4+ and, thus, the glass can easily achieve high light transmittance properties. As just described, when having a refractive index nd of 1.9 or more and a ratio Ti⁴⁺/Nb⁵⁺ of 2.1 or more, the glass can receive a greater benefit from the effect to be achieved by making the basicity high.

As described previously, the optical glass according to the present invention can achieve high transmittance properties with or without prolonged annealing treatment. In other words, the optical glass has a feature that the amount of change in internal transmittance thereof when subjected to prolonged annealing treatment is small. Specifically, in the optical glass according to the present invention, when the optical glass is thermally treated in a range of plus or minus 200° C. from the glass transition point for 72 hours, the amount of change in internal transmittance of the optical glass with a thickness of 10 mm at a wavelength of 450 nm is preferably less than 10%, more preferably 5% or less, more preferably less than 2%, more preferably 1.5% or less, more preferably 1% or less, more preferably 0.5% or less, and particularly preferably 0% (i.e., the internal transmittance does not change before and after the thermal treatment).

The lower limit of the refractive index (nd) of the optical glass according to the present invention is preferably not less than 1.8, more preferably not less than 1.85, still more preferably not less than 1.90, yet still more preferably not less than 1.95, and particularly preferably not less than 1.98, and the upper limit thereof is preferably not more than 2.3, more preferably not more than 2.1, still more preferably not more than 2.05, yet still more preferably not more than 2.03, and particularly preferably not more than 2.01. If the refractive index is too low, the glass tends to narrow the viewing angle when used as a light guide plate of a wearable image display device, such as projector-equipped eyeglasses, an eyeglass- or goggle-mounted display, a virtual reality (VR) or augmented reality (AR) display device, or a virtual image display device. On the other hand, if the refractive index is too high, the glass is likely to cause defects including devitrification and striae.

The Abbe's number (νd) of the optical glass according to the present invention is not particularly limited, but, in consideration of the stability of vitrification, the lower limit thereof is preferably not less than 20, more preferably not less than 22, and particularly preferably not less than 25, and the upper limit thereof is preferably not more than 35, more preferably not more than 32, and particularly preferably not more than 30.

The internal transmittance of the optical glass according to the present invention with a thickness of 10 mm at a wavelength of 450 nm is preferably 80% or more and particularly preferably 90% or more. Thus, in a wearable image display device using the optical glass according to the present invention, the brightness of images viewed by the user can be easily increased.

The liquidus temperature of the optical glass according to the present invention is preferably 1300° C. or lower, more preferably 1250° C. or lower, still more preferably 1150° C. or lower, yet still more preferably 1100° C. or lower, and particularly preferably 1070° C. or lower. Thus, the glass is difficult to devitrify during melting and molding, which easily increases the mass productivity.

The density of the optical glass according to the present invention is preferably 5.5 g/cm³ or less, more preferably 5.3 g/cm³ or less, and particularly preferably 5.1 g/cm³ or less. If the density is too high, the weight of a wearable device using the optical glass according to the present invention becomes large, which brings a greater feeling of discomfort to the user wearing the device. The lower limit of the density is not particularly limited. However, if the density is too low, other properties, such as optical properties, tend to decrease. Therefore, the lower limit of the density is preferably not less than 4 g/cm³ and particularly preferably not less than 4.5 g/cm³.

In the optical glass according to the present invention, the coefficient of thermal expansion at 30 to 300° C. is preferably 95×10⁻⁷/° C. or less, more preferably 91×10⁻⁷/° C. or less, and particularly preferably 88×10⁻⁷/° C. or less. If the coefficient of thermal expansion is too high, the glass is likely to be broken by thermal shock. The lower limit of the coefficient of thermal expansion is not particularly limited. However, if the coefficient of thermal expansion is too low, other properties, such as optical properties, tend to decrease. Therefore, the lower limit of the coefficient of thermal expansion is preferably not less than 75×10⁻⁷/° C. and particularly preferably not less than 80×10⁻⁷/° C.

The lower limit of the thickness of an optical glass plate made of the optical glass according to the present invention is preferably not less than 0.01 mm, more preferably not less than 0.02 mm, still more preferably not less than 0.03 mm, yet still more preferably not less than 0.04 mm, and particularly preferably not less than 0.05 mm, and the upper limit thereof is preferably not more than 5 mm, more preferably not more than 3 mm, still more preferably not more than 1 mm, yet still more preferably not more than 0.8 mm, even still more preferably not more than 0.6 mm, and particularly preferably not more than 0.3 mm. If the thickness of the optical glass plate is too small, the mechanical strength is likely to decrease. On the other hand, if the thickness of the optical glass plate is too large, the weight of a wearable image display device using the optical glass plate becomes large, which brings a greater feeling of discomfort to the user wearing the device.

The shape of the optical glass plate according to the present invention is, for example, a plate-like shape the planar shape of which is circular, elliptic or polygonal, such as rectangular. In this case, the maximum diameter of the optical glass plate (the diameter when the optical glass plate is circular) is preferably 50 mm or more, more preferably 80 mm or more, more preferably 100 mm or more, more preferably 120 mm or more, more preferably 150 mm or more, more preferably 160 mm or more, more preferably 170 mm or more, more preferably 180 mm or more, more preferably 190 mm or more, and particularly preferably 200 mm or more. If the maximum diameter of the optical glass plate is too small, the optical glass plate is difficult to use for a wearable image display device or like applications. In addition, the optical glass plate tends to have a poor mass productivity. The upper limit of the maximum diameter of the optical glass plate is not particularly limited, but it is actually not more than 1000 mm.

An optical glass according to the present invention includes the step of melting a raw material formulated to have a predetermined glass composition (the above-described glass composition having the predetermined basicity), thus obtaining molten glass, and then cooling the molten glass to obtain a molded body. In this relation, there is no need to further subject the molded body to thermal treatment in a range of plus or minus 200° C. from the glass transition point of the molded body for 48 hours or more. As described previously, the optical glass according to the present invention can achieve high transmittance properties with or without prolonged annealing treatment. Therefore, the production method according to the present invention can skip a prolonged thermal treatment step of subjecting the molded body to thermal treatment, for example, in a range of plus or minus 200° C. from the glass transition point of the molded body for 48 hours or more and, thus, has a feature of excellent mass productivity. The glass transition point of the optical glass according to the present invention is approximately 650 to 800° C.

The melting temperature is preferably 1400° C. or lower, more preferably 1350° C. or lower, still more preferably 1300° C. or lower, and particularly preferably 1280° C. or lower. If the melting temperature is too high, a component (such as Pt) of a melting container is likely to elute off in glass melt and, thus, the light transmittance of the obtained optical glass tends to decrease. On the other hand, if the melting temperature is low, the optical glass tends to be likely to produce bubbles or foreign substances (for example, foreign substances derived from unsolved substances). Therefore, in order to reduce bubbles and foreign substances in the glass, the melting temperature is preferably not lower than 1200° C. and particularly preferably not lower than 1250° C.

As described previously, by suitably controlling the content of B₂O₃+La₂O₃+ZnO, the content of SiO₂+Y₂O₃+ZrO₂ or the difference between these contents, the solubility can be increased and, thus, the production of bubbles and foreign substances in the optical glass can be reduced even upon melting at low temperatures. As a result, an optical glass having an excellent light transmittance, less bubbles, and less foreign substances can be obtained.

The optical glass plate according to the present invention is suitable as a light guide plate which is a component of a wearable image display device selected from among projector-equipped eyeglasses, an eyeglass- or goggle-mounted display, a virtual reality (VR) or augmented reality (AR) display device, and a virtual image display device. The light guide plate is used in so-called eyeglass lens portions of a wearable image displace device and plays a role in guiding light emitted from an image display element included in the wearable image display device to emit the light toward the eyes of the user. The light guide plate is preferably provided at the surface with a diffracting grating for diffracting light emitted from the image display element to the interior of the light guide plate.

### EXAMPLES

Hereinafter, the present invention will be described in detail with reference to examples, but the present invention is not limited to these examples.

Tables 2 to 8 show examples of the present invention. Tables 2 to 5 are mainly for the purpose of comparison among the amounts of change in internal transmittance to be described later, wherein compositions equal in the total content of TiO₂ and Nb₂O₅, which has a significant effect on the internal transmittance, are shown collectively side by side.

TABLE 2

| | | | No. | No. | No. | No. | No. |
|---|---|---|---|---|---|---|---|
| | | Unit | 1-1 | 1-2 | 1-3 | 1-4 | 1-5 |
| Glass | SiO₂ | % by | 16.4 | 16.4 | 16.4 | 12.4 | 14.3 |
| Composition | B₂O₃ | mole | 19 | 18.9 | 18.8 | 18.9 | 18 |
| | TiO₂ | | 27.4 | 27.4 | 27.4 | 27.4 | 27.4 |
| | Nb₂O₅ | | 4.2 | 4.2 | 4.2 | 4.2 | 4.2 |
| | ZrO₂ | | 7.2 | 7.2 | 7.2 | 7.2 | 7.2 |
| | La₂O₃ | | 19.1 | 22.2 | 22.1 | 22.1 | 22.2 |
| | Gd₂O₃ | | 3.2 | 3.2 | 3.2 | 4.3 | 3.2 |
| | Y₂O₃ | | 3.5 | 0.5 | 0.7 | 3.5 | 3.5 |
| TiO₂ + Nb₂O₅ | | % by | 31.6 | 31.6 | 31.6 | 31.6 | 31.6 |
| | | mole | | | | | |
| TiO₂/Nb₂O₅ | | — | 6.5 | 6.5 | 6.5 | 6.5 | 6.5 |
| B₂O₃/SiO₂ | | — | 1.16 | 1.15 | 1.15 | 1.52 | 1.26 |
| Ln₂O₃ | | % by | 25.8 | 25.9 | 26.0 | 29.9 | 28.9 |
| | | mole | | | | | |
| (SiO₂ + B₂O₃)/Ln₂O₃ | | — | 1.37 | 1.36 | 1.35 | 1.05 | 1.12 |
| Nb₂O₅/(TiO₂ + Nb₂O₅ + ZrO₂) | | — | 0.11 | 0.11 | 0.11 | 0.11 | 0.11 |
| TiO₂ + Nb₂O₅ + WO₃ | | % by | 31.6 | 31.6 | 31.6 | 31.6 | 31.6 |
| | | mole | | | | | |
| Nb₂O₅/(TiO₂ + Nb₂O₅ + WO₃) | | — | 0.13 | 0.13 | 0.13 | 0.13 | 0.13 |
| Y₂O₃/Ln₂O₃ | | — | 0.14 | 0.02 | 0.03 | 0.12 | 0.12 |
| Gd₂O₃/Ln₂O₃ | | — | 0.12 | 0.12 | 0.12 | 0.14 | 0.11 |
| (TiO₂ + B₂O₃)/(Nb₂O₅ + WO₃) | | — | 11.0 | 11.0 | 11.0 | 11.0 | 10.8 |
| B₂O₃ + La₂O₃ + ZnO | | % by | 38.1 | 41.1 | 40.9 | 41.0 | 40.2 |
| | | mole | | | | | |
| SiO₂ + Y₂O₃ + ZrO₂ | | % by | 27.1 | 24.1 | 24.3 | 23.1 | 25.0 |
| | | mole | | | | | |
| (B₂O₃ + La₂O₃ + ZnO) − | | % by | 11.0 | 17.0 | 16.6 | 17.9 | 15.2 |
| (SiO₂ + Y₂O₃ + ZrO₂) | | mole | | | | | |
| Ti⁴⁺/Nb⁵⁺ | | — | 3.3 | 3.3 | 3.3 | 3.3 | 3.3 |
| Si⁴⁺ + B³⁺ | | % by | 36.5 | 36.4 | 36.2 | 32.8 | 33.3 |
| | | cation | | | | | |
| Basicity | | — | 13.1 | 13.2 | 13.2 | 14.0 | 14.0 |
| Water Resistance/Acid | | class/ | 1/1 | 1/1 | 1/1 | 1/1 | 1/1 |
| Resistance | | class | | | | | |
| Liquidus Temperature | | ° C. | — | 1130 | — | — | — |
| Liquidus Viscosity | | dPa · s | — | 10¹ | — | — | 10¹ |
| Refractive Index (nd) | | — | 1.990 | 1.996 | 1.994 | 2.006 | 2.004 |
| Abbe's Number (νd) | | — | 28.6 | 28.8 | 28.7 | 29.0 | 28.9 |
| Density | | g/cm³ | 4.7 | 5 | 5 | 5.1 | 5.1 |
| Glass Transition Point | | ° C. | 715 | 715 | 715 | — | — |
| Coefficient of Thermal | | ×10⁻⁷/° C. | 83 | 84 | 83 | — | — |
| Expansion | | | | | | | |
| Internal | Before | % | 84 | 88 | 88 | 91 | 95 |
| Transmittance | Thermal | | | | | | |
| @ 450 nm | Treatment | | | | | | |
| | After | % | 93 | 94 | 93 | 91 | 95 |
| | Thermal | | | | | | |
| | Treatment | | | | | | |
| | Amount of | % | 9 | 6 | 5 | 0 | 0 |
| | Change | | | | | | |

TABLE 3

| | | | No. | No. | No. | No. | No. |
|---|---|---|---|---|---|---|---|
| | | Unit | 2-1 | 2-2 | 2-3 | 2-4 | 2-5 |
| Glass | SiO₂ | % by | 16.4 | 16.4 | 17.4 | 17.4 | 16.4 |
| Composition | B₂O₃ | mole | 19 | 16 | 16 | 16 | 17 |
| | TiO₂ | | 27.4 | 26.4 | 26.4 | 27.4 | 27.4 |
| | Nb₂O₅ | | 3.2 | 4.2 | 4.2 | 3.2 | 3.2 |
| | ZrO₂ | | 7.2 | 7.2 | 7.2 | 7.2 | 7.2 |
| | La₂O₃ | | 22.1 | 23.1 | 22.1 | 22.1 | 22.1 |
| | Gd₂O₃ | | 3.2 | 3.2 | 3.2 | 3.2 | 3.2 |
| | Y₂O₃ | | 1.5 | 3.5 | 3.5 | 3.5 | 3.5 |
| TiO₂ + Nb₂O₅ | | % by | 30.6 | 30.6 | 30.6 | 30.6 | 30.6 |
| | | mole | | | | | |
| TiO₂/Nb₂O₅ | | — | 8.6 | 6.3 | 6.3 | 8.6 | 8.6 |
| B₂O₃/SiO₂ | | — | 1.16 | 0.98 | 0.92 | 0.92 | 1.04 |
| Ln₂O₃ | | % by | 26.8 | 29.8 | 28.8 | 28.8 | 28.8 |
| | | mole | | | | | |
| (SiO₂ + B₂O₃)/Ln₂O₃ | | — | 1.32 | 1.09 | 1.16 | 1.16 | 1.16 |
| Nb₂O₅/(TiO₂ + Nb₂O₅ + ZrO₂) | | — | 0.08 | 0.11 | 0.11 | 0.08 | 0.08 |
| TiO₂ + Nb₂O₅ + WO₃ | | % by | 30.6 | 30.6 | 30.6 | 30.6 | 30.6 |
| | | mole | | | | | |
| Nb₂O₅/(TiO₂ + Nb₂O₅ + WO₃) | | — | 0.10 | 0.14 | 0.14 | 0.10 | 0.10 |
| Y₂O₃/Ln₂O₃ | | — | 0.06 | 0.12 | 0.12 | 0.12 | 0.12 |
| Gd₂O₃/Ln₂O₃ | | — | 0.12 | 0.11 | 0.11 | 0.11 | 0.11 |
| (TiO₂ + B₂O₃)/(Nb₂O₅ + WO₃) | | — | 14.5 | 10.1 | 10.1 | 13.6 | 13.9 |
| B₂O₃ + La₂O₃ + ZnO | | % by | 41.1 | 39.1 | 38.1 | 38.1 | 39.1 |
| | | mole | | | | | |
| SiO₂ + Y₂O₃ + ZrO₂ | | % by | 25.1 | 27.1 | 28.1 | 28.1 | 27.1 |
| | | mole | | | | | |
| (B₂O₃ + La₂O₃ + ZnO) − | | % by | 16.0 | 12.0 | 10.0 | 10.0 | 12.0 |
| (SiO₂ + Y₂O₃ + ZrO₂) | | mole | | | | | |
| Ti⁴⁺/Nb⁵⁺ | | — | 4.3 | 3.1 | 3.1 | 4.3 | 4.3 |
| Si⁴⁺ + B³⁺ | | % by | 36.5 | 32.3 | 33.2 | 33.4 | 33.8 |
| | | cation | | | | | |
| Basicity | | — | 13.1 | 14.4 | 14.2 | 14.1 | 13.9 |
| Water Resistance/Acid | | class/ | 1/1 | 1/1 | 1/1 | 1/1 | 1/1 |
| Resistance | | class | | | | | |
| Liquidus Temperature | | ° C. | | — | — | — | — |
| Liquidus Viscosity | | dPa · s | | — | — | — | 10¹ |
| Refractive Index (nd) | | — | 1.987 | 2.002 | 1.999 | 1.996 | 1.995 |
| Abbe's Number (νd) | | — | 28.7 | 28.9 | 29.2 | 29.4 | 29.4 |
| Density | | g/cm³ | 4.7 | — | 5 | 5 | 5.1 |
| Glass Transition Point | | ° C. | 710 | — | 720 | 720 | — |
| Coefficient of Thermal | | ×10⁻⁷° C. | 82 | — | 81 | 81 | — |
| Expansion | | | | | | | |
| Internal | Before | % | 91 | 90 | 91 | 94 | 93 |
| Transmittance | Thermal | | | | | | |
| @ 450 nm | Treatment | | | | | | |
| | After | % | 93 | 90 | 91 | 94 | 93 |
| | Thermal | | | | | | |
| | Treatment | | | | | | |
| | Amount of | % | 2 | 0 | 0 | 0 | 0 |
| | Change | | | | | | |

TABLE 4

| | | | No. | No. | No. | No. | No. |
|---|---|---|---|---|---|---|---|
| | | Unit | 3-1 | 3-2 | 3-3 | 4-1 | 4-2 |
| Glass | SiO₂ | % by | 16 | 16 | 17 | 16.4 | 16.4 |
| Composition | B₂O₃ | mole | 21 | 20.2 | 18.2 | 19 | 19 |
| | TiO₂ | | 26.4 | 26.4 | 26.4 | 27.4 | 24.4 |
| | Nb₂O₅ | | 3.2 | 3.2 | 3.2 | 1.2 | 4.2 |
| | ZrO₂ | | 8.2 | 7.2 | 7.2 | 7.2 | 7.2 |
| | La₂O₃ | | 19.2 | 22.2 | 22.2 | 22.1 | 22.1 |
| | Gd₂O₃ | | 4.5 | 4.3 | 5.3 | 3.2 | 3.2 |
| | Y₂O₃ | | 1.5 | 0.5 | 0.5 | 3.5 | 3.5 |
| TiO₂ + Nb₂O₅ | | % by | 29.6 | 29.6 | 29.6 | 28.6 | 28.6 |
| | | mole | | | | | |
| TiO₂/Nb₂O₅ | | — | 8.3 | 8.3 | 8.3 | 22.8 | 5.8 |
| B₂O₃/SiO₂ | | — | 1.31 | 1.26 | 1.07 | 1.16 | 1.16 |
| Ln₂O₃ | | % by | 25.2 | 27.0 | 28.0 | 28.8 | 28.8 |
| | | mole | | | | | |
| (SiO₂ + B₂O₃)/Ln₂O₃ | | — | 1.47 | 1.34 | 1.26 | 1.23 | 1.23 |
| Nb₂O₅/(TiO₂ + Nb₂O₅ + ZrO₂) | | — | 0.08 | 0.09 | 0.09 | 0.03 | 0.12 |
| TiO₂ + Nb₂O₅ + WO₃ | | % by | 29.6 | 29.6 | 29.6 | 28.6 | 28.6 |
| | | mole | | | | | |
| Nb₂O₅/(TiO₂ + Nb₂O₅ + WO₃) | | — | 0.11 | 0.11 | 0.11 | 0.04 | 0.15 |
| Y₂O₃/Ln₂O₃ | | — | 0.06 | 0.02 | 0.02 | 0.12 | 0.12 |
| Gd₂O₃/Ln₂O₃ | | — | 0.18 | 0.16 | 0.19 | 0.11 | 0.11 |
| (TiO₂ + B₂O₃)/(Nb₂O₅ + WO₃) | | — | 14.8 | 14.6 | 13.9 | 38.7 | 10.3 |
| B₂O₃ + La₂O₃ + ZnO | | % by | 40.2 | 42.4 | 40.4 | 41.1 | 41.1 |
| | | mole | | | | | |
| SiO₂ + Y₂O₃ + ZrO₂ | | % by | 25.7 | 23.7 | 24.7 | 27.1 | 27.1 |
| | | mole | | | | | |
| (B₂O₃ + La₂O₃ + ZnO) − | | % by | 14.5 | 18.7 | 15.7 | 14.0 | 14.0 |
| (SiO₂ + Y₂O₃ + ZrO₂) | | mole | | | | | |
| Ti⁴⁺/Nb⁵⁺ | | — | 4.1 | 4.1 | 4.1 | 11.4 | 2.9 |
| Si⁴⁺ + B³⁺ | | % by | 38.8 | 37.5 | 35.7 | 36.5 | 35.8 |
| | | cation | | | | | |
| Basicity | | — | 12.5 | 12.8 | 13.4 | 13.1 | 13.3 |
| Water Resistance/Acid | | class/ | 1/1 | 1/1 | 1/1 | 1/1 | 1/1 |
| Resistance | | class | | | | | |
| Liquidus Temperature | | ° C. | — | — | — | — | — |
| Liquidus Viscosity | | dPa · s | — | — | — | — | — |
| Refractive Index (nd) | | — | 1.977 | 1.983 | 1.989 | 1.975 | 1.983 |
| Abbe's Number (νd) | | — | — | — | — | — | — |
| Density | | g/cm³ | 4.8 | 4.9 | 4.9 | 4.8 | — |
| Glass Transition Point | | ° C. | — | — | — | — | — |
| Coefficient of Thermal | | ×10⁻⁷/° C. | — | — | — | — | — |
| Expansion | | | | | | | |
| Internal | Before | % | 88 | 88 | 94 | 91 | 93 |
| Transmittance | Thermal | | | | | | |
| @ 450 nm | Treatment | | | | | | |
| | After | % | 92 | 90.5 | 94 | 93 | 93 |
| | Thermal | | | | | | |
| | Treatment | | | | | | |
| | Amount of | % | 4 | 2.5 | 0 | 2 | 0 |
| | Change | | | | | | |

TABLE 5

| | | | No. | No. | No. | No. | No. | No. | No. | No. |
|---|---|---|---|---|---|---|---|---|---|---|
| | | Unit | 5-1 | 5-2 | 5-3 | 5-4 | 5-5 | 6-1 | 6-2 | 7-1 |
| Glass | SiO₂ | % by | 48.2 | 39.5 | 41.5 | 39.5 | 39.5 | 48.6 | 49.4 | 41.4 |
| Composition | B₂O₃ | mole | | | | | | | 0.6 | |
| | Li₂O | | 5.1 | 16 | 16 | 16 | 18 | 3 | 3 | 16 |
| | Na₂O | | 15.6 | 15.4 | 15.4 | 15.4 | 15.4 | 16.9 | 15.5 | 15.4 |
| | TiO₂ | | 15 | 14.6 | 14.6 | 14.6 | 14.6 | 15 | 15 | 8.4 |
| | Nb₂O₅ | | 12.1 | 12.5 | 12.5 | 12.5 | 12.5 | 12.5 | 12.5 | 15 |
| | ZrO₂ | | 4 | 2 | | | | 4 | 4 | |
| | Ta₂O₅ | | | | | | | | | 3.7 |
| | BaO | | | | | 2 | | | | |
| TiO₂ + Nb₂O₅ | | % by | 27.1 | 27.1 | 27.1 | 27.1 | 27.1 | 27.5 | 27.5 | 23.4 |
| | | mole | | | | | | | | |
| TiO₂/Nb₂O₅ | | — | 1.2 | 1.2 | 1.2 | 1.2 | 1.2 | 1.2 | 1.2 | 0.6 |
| B₂O₃/SiO₂ | | — | 0 | 0 | 0 | 0 | 0 | 0 | 0.012 | 0 |
| Ln₂O₃ | | % by | 0 | 0 | 0 | 0 | 0 | 0 | 0 | 0 |
| | | mole | | | | | | | | |
| (SiO₂ + B₂O₃)/Ln₂O₃ | | — | — | — | — | — | — | — | — | — |
| Nb₂O₅/(TiO₂ + Nb₂O₅ + ZrO₂) | | — | 0.39 | 0.43 | 0.46 | 0.46 | 0.46 | 0.40 | 0.40 | 0.64 |
| TiO₂ + Nb₂O₅ + WO₃ | | % by | 27.1 | 27.1 | 27.1 | 27.1 | 27.1 | 27.5 | 27.5 | 23.4 |
| | | mole | | | | | | | | |
| Nb₂O₅/(TiO₂ + Nb₂O₅ + WO₃) | | — | 0.45 | 0.46 | 0.46 | 0.46 | 0.46 | 0.45 | 0.45 | 0.64 |
| Y₂O₃/Ln₂O₃ | | — | — | — | — | — | — | — | — | — |
| Gd₂O₃/Ln₂O₃ | | — | — | — | — | — | — | — | — | — |
| (TiO₂ + B₂O₃)/(Nb₂O₅ + WO₃) | | — | 1.2 | 1.2 | 1.2 | 1.2 | 1.2 | 1.2 | 1.2 | 0.6 |
| B₂O₃ + La₂O₃ + ZnO | | % by | 0 | 0 | 0 | 0 | 0 | 0 | 0.6 | 0 |
| | | mole | | | | | | | | |
| SiO₂ + Y₂O₃ + ZrO₂ | | % by | 52.2 | 41.5 | 41.5 | 39.5 | 39.5 | 52.6 | 53.4 | 41.4 |
| | | mole | | | | | | | | |
| (B₂O₃ + La₂O₃ + ZnO) − | | % by | −52.2 | −41.5 | −41.5 | −39.5 | −39.5 | −52.6 | −52.8 | −41.4 |
| (SiO₂ + Y₂O₃ + ZrO₂) | | mole | | | | | | | | |
| Ti⁴⁺/Nb⁵⁺ | | — | 0.63 | 0.58 | 0.58 | 0.28 | 0.58 | 0.58 | 0.60 | 0.60 |
| Si⁴⁺ + B³⁺ | | % by | 36.3 | 27.4 | 28.8 | 27.6 | 27.4 | 27.1 | 36.7 | 38.4 |
| | | cation | | | | | | | | |
| Basicity | | — | 13.7 | 15.0 | 14.6 | 15.0 | 14.9 | 13.8 | 13.4 | 15.4 |
| Water Resistance/Acid | | class/ | — | 1/1 | — | 1/1 | 1/1 | 1/1 | 1/1 | — |
| Resistance | | class | | | | | | | | |
| Liquidus Temperature | | ° C. | — | 1035 | — | 1035 | 1030 | 1020 | 1045 | — |
| Liquidus Viscosity | | dPa · s | — | 10¹ | — | 10¹ | 10¹ | 10² | 10² | — |
| Refractive Index (nd) | | — | — | 1.83 | 1.821 | 1.825 | 1.813 | 1.816 | 1.816 | 1.848 |
| Abbe's Number (νd) | | — | — | 25.3 | 25.4 | 25.6 | 25.5 | 24.5 | 24.3 | 25.2 |
| Density | | g/cm³ | — | 3.33 | — | 3.36 | 3.29 | 3.31 | 3.3 | — |
| Glass Transition Point | | ° C. | — | 530 | — | 530 | 520 | 595 | 590 | — |
| Coefficient of Thermal | | ×10⁻⁷/° C. | — | 109 | — | 112 | 113 | 84 | 80 | — |
| Expansion | | | | | | | | | | |
| Internal | Before | % | 89 | 90 | 89 | 89 | 89 | 88 | 85 | 90 |
| Transmittance | Thermal | | | | | | | | | |
| @450 nm | Treatment | | | | | | | | | |
| | After | % | 92 | 90 | 90 | 89 | 89 | 90 | 90 | 90 |
| | Thermal | | | | | | | | | |
| | Treatment | | | | | | | | | |
| | Amount of | % | 3 | 0 | 1 | 0 | 0 | 2 | 5 | 0 |
| | Change | | | | | | | | | |

TABLE 6

| | | | No. | No. | No. | No. | No. | No. |
|---|---|---|---|---|---|---|---|---|
| | | Unit | 8-1 | 8-2 | 8-3 | 8-4 | 8-5 | 8-6 |
| Glass | SiO₂ | % by | 14.0 | 14.0 | 11.5 | 10.5 | 10.6 | 10.6 |
| Composition | B₂O₃ | mole | 21.2 | 18.1 | 23.4 | 21.6 | 21.9 | 21.0 |
| | TiO₂ | | 27.5 | 27.5 | 27.6 | 28.0 | 28.5 | 28.5 |
| | Nb₂O₅ | | 4.2 | 4.3 | 4.2 | 4.6 | 4.63 | 4.60 |
| | ZrO₂ | | 7.2 | 7.2 | 7.2 | 7.3 | 6.8 | 6.8 |
| | La₂O₃ | | 22.2 | 20.8 | 22.3 | 22.7 | 23.0 | 23.0 |
| | Gd₂O₃ | | 3.2 | 3.2 | 3.2 | 3.3 | 4.0 | 4.0 |
| | Y₂O₃ | | 0.5 | 3.5 | 0.5 | 0.5 | 0.6 | 0.6 |
| | SrO | | | 1.5 | | 1.5 | | |
| | BaO | | | | | | | |
| | ZnO | | | | | | | 0.9 |
| TiO₂ + Nb₂O₅ | | % by | 31.7 | 31.8 | 31.8 | 32.6 | 33.1 | 33.1 |
| | | mole | | | | | | |
| TiO₂/Nb₂O₅ | | — | 6.6 | 6.4 | 6.6 | 6.1 | 6.1 | 6.2 |
| B₂O₃/SiO₂ | | — | 1.51 | 1.29 | 2.03 | 2.06 | 2.06 | 1.98 |
| Ln₂O₃ | | % by | 26.0 | 27.5 | 26.1 | 26.5 | 27.5 | 27.6 |
| | | mole | | | | | | |
| RO | | % by | 0.0 | 1.5 | 0.0 | 1.5 | 0.0 | 0.0 |
| | | mole | | | | | | |
| (SiO₂ + B₂O₃)/Ln₂O₃ | | — | 1.35 | 1.17 | 1.34 | 1.21 | 1.18 | 1.14 |
| Nb₂O₅/(TiO₂ + Nb₂O₅ + ZrO₂) | | — | 0.11 | 0.11 | 0.11 | 0.11 | 0.12 | 0.12 |
| TiO₂ + Nb₂O₅ + WO₃ | | % by | 31.7 | 31.8 | 31.8 | 32.6 | 33.1 | 33.1 |
| | | mole | | | | | | |
| Nb₂O₅/(TiO₂ + Nb₂O₅ + WO₃) | | — | 0.13 | 0.14 | 0.13 | 0.14 | 0.14 | 0.14 |
| Y₂O₃/Ln₂O₃ | | — | 0.02 | 0.13 | 0.02 | 0.02 | 0.02 | 0.02 |
| Gd₂O₃/Ln₂O₃ | | — | 0.12 | 0.12 | 0.12 | 0.12 | 0.14 | 0.14 |
| (TiO₂ + B₂O₃)/(Nb₂O₅ + WO₃) | | — | 11.6 | 10.6 | 12.1 | 10.9 | 10.9 | 10.8 |
| B₂O₃ + La₂O₃ + ZnO | | % by | 43.4 | 38.8 | 45.7 | 44.3 | 45.0 | 44.9 |
| | | mole | | | | | | |
| SiO₂ + Y₂O₃ + ZrO₂ | | % by | 21.7 | 24.7 | 19.3 | 18.4 | 18.0 | 18.0 |
| | | mole | | | | | | |
| (B₂O₃ + La₂O₃ + ZnO) − | | % by | 21.7 | 14.1 | 26.4 | 25.9 | 27.0 | 26.9 |
| (SiO₂ + Y₂O₃ + ZrO₂) | | mole | | | | | | |
| Ti⁴⁺/Nb⁵⁺ | | — | 3.3 | 3.2 | 3.3 | 3.1 | 3.1 | 3.1 |
| Si⁴⁺ + B³⁺ | | % by | 37.2 | 33.4 | 38.0 | 35.2 | 35.3 | 34.3 |
| | | cation | | | | | | |
| Solubility | | | | | | | | |
| Melting Temperature | | | | | | | | |
| 1270° C. | Number of | per cm³ | 0.08 | 0.25 | 0.09 | 0.09 | 0.08 | 0.10 |
| | Defects | | | | | | | |
| | (Bubbles, | | | | | | | |
| | Foreign | | | | | | | |
| | Substances) | | | | | | | |
| | External | % | 77.3 | 77.4 | 77.3 | 77.4 | 77.5 | 77.1 |
| | Transmittance | | | | | | | |
| | @450 nm | | | | | | | |
| 1300° C. | Number of | per cm³ | 0.02 | 0.13 | 0.02 | 0.02 | 0.00 | 0.00 |
| | Defects | | | | | | | |
| | (Bubbles, | | | | | | | |
| | Foreign | | | | | | | |
| | Substances) | | | | | | | |
| | External | % | 76.9 | 76.7 | 76.5 | 76.9 | 76.6 | 76.9 |
| | Transmittance | | | | | | | |
| | @450 nm | | | | | | | |
| 1330° C. | Number of | per cm³ | 0.00 | 0.00 | 0.00 | 0.00 | 0.00 | 0.00 |
| | Defects | | | | | | | |
| | (Bubbles, | | | | | | | |
| | Foreign | | | | | | | |
| | Substances) | | | | | | | |
| | External | % | 76.5 | 76.1 | 76.2 | 76.2 | 76.0 | 76.2 |
| | Transmittance | | | | | | | |
| | @450 nm | | | | | | | |
| Basicity | | — | 12.8 | 13.8 | 12.5 | 13.1 | 13.1 | 13.4 |
| Water Resistance/Acid | | class/ | 1/1 | 1/1 | 1/1 | 1/1 | 1/1 | 1/1 |
| Resistance | | class | | | | | | |
| Refractive Index (nd) | | — | 2.004 | 2.004 | 2.003 | 2.009 | 2.018 | 2.017 |
| Abbe's Number (νd) | | — | 29.0 | 29.0 | 29.0 | 29.1 | 29.3 | 29.3 |
| Density | | g/cm³ | 5.04 | 5.05 | 5.03 | 5.10 | 5.20 | 5.20 |
| Internal | Before | % | 96 | 96 | 94 | 96 | 96 | 96 |
| Transmittance | Thermal | | | | | | | |
| @450 nm | Treatment | | | | | | | |
| | After | % | 96 | 97 | 96 | 96 | 97 | 97 |
| | Thermal | | | | | | | |
| | Treatment | | | | | | | |
| | Amount of | % | 0 | 1 | 2 | 0 | 1 | 1 |
| | Change | | | | | | | |

| | | | | | | | |
|---|---|---|---|---|---|---|---|
| Pt Content | ppm | 3.4 | 4.9 | 5.9 | 4.4 | 5.1 | 4.7 |
| Rh Content | ppm | 0.03 | 0.07 | 0.05 | 0.06 | 0.07 | 0.04 |
| Fe₂O₃ Content | ppm | <0.5 | <0.5 | <0.5 | <0.5 | <0.5 | <0.5 |

TABLE 7

| | | | No. | No. | No. | No. | No. | No. |
|---|---|---|---|---|---|---|---|---|
| | | Unit | 8-7 | 8-8 | 8-9 | 8-10 | 8-11 | 8-12 |
| Glass | SiO₂ | % by | 9.3 | 9.4 | 9.1 | 9.0 | 9.1 | 9.0 |
| Composition | B₂O₃ | mole | 23.0 | 23.2 | 25.7 | 23.9 | 21.9 | 22.8 |
| | TiO₂ | | 28.4 | 28.7 | 27.7 | 27.9 | 28.2 | 27.9 |
| | Nb₂O₅ | | 4.6 | 4.66 | 4.2 | 4.4 | 4.4 | 4.4 |
| | ZrO₂ | | 7.4 | 5.0 | 7.2 | 6.1 | 7.4 | 7.3 |
| | La₂O₃ | | 23.2 | 23.9 | 22.4 | 23.5 | 23.7 | 23.0 |
| | Gd₂O₃ | | 3.5 | 3.5 | 3.2 | 3.3 | 3.3 | 3.3 |
| | Y₂O₃ | | 0.6 | 0.6 | 0.5 | 0.5 | 0.5 | 0.8 |
| | SrO | | | | | 1.5 | | 1.5 |
| | BaO | | | 1.0 | | | 1.5 | |
| | ZnO | | | | | | | |
| TiO₂ + Nb₂O₅ | | % by | 33.0 | 33.3 | 31.9 | 32.3 | 32.6 | 32.3 |
| | | mole | | | | | | |
| TiO₂/Nb₂O₅ | | — | 6.1 | 6.1 | 6.6 | 6.4 | 6.4 | 6.4 |
| B₂O₃/SiO₂ | | — | 2.47 | 2.47 | 2.83 | 2.64 | 2.40 | 2.52 |
| Ln₂O₃ | | % by | 27.3 | 28.0 | 26.1 | 27.2 | 27.5 | 27.1 |
| | | mole | | | | | | |
| RO | | % by | 0.0 | 1.0 | 0.0 | 1.5 | 1.5 | 1.5 |
| | | mole | | | | | | |
| (SiO₂ + B₂O₃)/Ln₂O₃ | | — | 1.18 | 1.16 | 1.33 | 1.21 | 1.13 | 1.18 |
| Nb₂O₅/(TiO₂ + Nb₂O₅ + ZrO₂) | | — | 0.11 | 0.12 | 0.11 | 0.11 | 0.11 | 0.11 |
| TiO₂ + Nb₂O₅ + WO₃ | | % by | 33.0 | 33.3 | 31.9 | 32.3 | 32.6 | 32.3 |
| | | mole | | | | | | |
| Nb₂O₅/(TiO₂ + Nb₂O₅ + WO₃) | | — | 0.14 | 0.14 | 0.13 | 0.14 | 0.14 | 0.14 |
| Y₂O₃/Ln₂O₃ | | — | 0.02 | 0.02 | 0.02 | 0.02 | 0.02 | 0.03 |
| Gd₂O₃/Ln₂O₃ | | — | 0.13 | 0.13 | 0.12 | 0.12 | 0.12 | 0.12 |
| (TiO₂ + B₂O₃)/(Nb₂O₅ + WO₃) | | — | 11.1 | 11.1 | 12.7 | 11.9 | 11.4 | 11.6 |
| B₂O₃ + La₂O₃ + ZnO | | % by | 46.2 | 47.2 | 48.0 | 47.3 | 45.6 | 45.7 |
| | | mole | | | | | | |
| SiO₂ + Y₂O₃ + ZrO₂ | | % by | 17.3 | 14.9 | 16.9 | 15.6 | 17.0 | 17.2 |
| | | mole | | | | | | |
| (B₂O₃ + La₂O₃ + ZnO) − | | % by | 28.9 | 32.2 | 31.2 | 31.7 | 28.5 | 28.5 |
| (SiO₂ + Y₂O₃ + ZrO₂) | | mole | | | | | | |
| Ti⁴⁺/Nb⁵⁺ | | — | 3.1 | 3.1 | 3.3 | 3.2 | 3.2 | 3.2 |
| Si⁴⁺ + B³⁺ | | % by | 35.7 | 35.8 | 38.7 | 36.5 | 34.4 | 35.4 |
| | | cation | | | | | | |
| Solubility | | | | | | | | |
| Melting Temperature | | | | | | | | |
| 1270° C. | Number of | per cm³ | 0.12 | 0.04 | 0.00 | 0.07 | 0.13 | 0.10 |
| | Defects | | | | | | | |
| | (Bubbles, | | | | | | | |
| | Foreign | | | | | | | |
| | Substances) | | | | | | | |
| | External | % | 77.2 | 77.0 | 77.4 | 77.5 | 77.2 | 77.5 |
| | Transmittance | | | | | | | |
| | @450 nm | | | | | | | |
| 1300° C. | Number of | per cm³ | 0.02 | 0.00 | 0.00 | 0.00 | 0.02 | 0.00 |
| | Defects | | | | | | | |
| | (Bubbles, | | | | | | | |
| | Foreign | | | | | | | |
| | Substances) | | | | | | | |
| | External | % | 77.0 | 76.6 | 76.7 | 76.5 | 76.9 | 77.0 |
| | Transmittance | | | | | | | |
| | @450 nm | | | | | | | |
| 1330° C. | Number of | per cm³ | 0.00 | 0.00 | 0.00 | 0.00 | 0.00 | 0.00 |
| | Defects | | | | | | | |
| | (Bubbles, | | | | | | | |
| | Foreign | | | | | | | |
| | Substances) | | | | | | | |
| | External | % | 76.0 | 76.4 | 76.1 | 76.0 | 76.4 | 76.1 |
| | Transmittance | | | | | | | |
| | @450 nm | | | | | | | |
| Basicity | | — | 12.9 | 12.9 | 12.1 | 12.7 | 13.3 | 13.0 |
| Water Resistance/Acid | | class/ | 1/1 | 1/1 | 1/1 | 1/1 | 1/1 | 1/1 |
| Resistance | | class | | | | | | |
| Refractive Index (nd) | | — | 2.018 | 2.005 | 2.002 | 2.001 | 2.012 | 2.007 |
| Abbe's Number (νd) | | — | 29.3 | 29.0 | 29.0 | 28.9 | 29.2 | 29.1 |
| Density | | g/cm³ | 5.21 | 5.06 | 5.02 | 5.01 | 5.14 | 5.08 |
| Internal | Before | % | 96 | 95 | 94 | 96 | 95 | 97 |
| Transmittance | Thermal | | | | | | | |
| @450 nm | Treatment | | | | | | | |
| | After | % | 97 | 95 | 96 | 96 | 95 | 97 |
| | Thermal | | | | | | | |
| | Treatment | | | | | | | |
| | Amount of | % | 1 | 0 | 2 | 0 | 0 | 0 |
| | Change | | | | | | | |

| | | | | | | | |
|---|---|---|---|---|---|---|---|
| Pt Content | ppm | 6.3 | 4.8 | 3.9 | 3.1 | 5.6 | 5.0 |
| Rh Content | ppm | 0.03 | 0.05 | <0.01 | <0.01 | 0.04 | 0.08 |
| Fe₂O₃ Content | ppm | <0.5 | <0.5 | <0.5 | <0.5 | <0.5 | <0.5 |

TABLE 8

| | | | No. | No. | No. | No. | No. |
|---|---|---|---|---|---|---|---|
| | | Unit | 8-13 | 8-14 | 8-15 | 8-16 | 8-17 |
| Glass | SiO₂ | % by | 9.0 | 9.0 | 9.0 | 6.5 | 3.9 |
| Composition | B₂O₃ | mole | 22.8 | 22.7 | 22.6 | 26.2 | 27.2 |
| | TiO₂ | | 27.7 | 27.8 | 27.7 | 28.0 | 27.9 |
| | Nb₂O₅ | | 4.4 | 4.3 | 4.3 | 4.5 | 4.4 |
| | ZrO₂ | | 7.3 | 7.3 | 7.3 | 6.1 | 7.3 |
| | La₂O₃ | | 23.0 | 21.9 | 20.9 | 23.5 | 21.1 |
| | Gd₂O₃ | | 3.3 | 3.2 | 3.2 | 3.3 | 3.3 |
| | Y₂O₃ | | 1.8 | 2.2 | 3.5 | 0.3 | 3.6 |
| | SrO | | | | 1.5 | | 1.5 |
| | BaO | | | 1.5 | | 1.5 | |
| | ZnO | | 0.8 | | | | |
| TiO₂ + Nb₂O₅ | | % by | 32.0 | 32.1 | 32.0 | 32.5 | 32.2 |
| | | mole | | | | | |
| TiO₂/Nb₂O₅ | | — | 6.3 | 6.4 | 6.4 | 6.2 | 6.4 |
| B₂O₃/SiO₂ | | — | 2.52 | 2.52 | 2.52 | 4.03 | 6.97 |
| Ln₂O₃ | | % by | 28.1 | 27.4 | 27.7 | 27.1 | 27.9 |
| | | mole | | | | | |
| RO | | % by | 0.0 | 1.5 | 1.5 | 1.5 | 1.5 |
| | | mole | | | | | |
| (SiO₂ + B₂O₃)/Ln₂O₃ | | — | 1.13 | 1.16 | 1.14 | 1.20 | 1.11 |
| Nb₂O₅/(TiO₂ + Nb₂O₅ + ZrO₂) | | — | 0.11 | 0.11 | 0.11 | 0.12 | 0.11 |
| TiO₂ + Nb₂O₅ + WO₃ | | % by | 32.0 | 32.1 | 32.0 | 32.5 | 32.2 |
| | | mole | | | | | |
| Nb₂O₅/(TiO₂ + Nb₂O₅ + WO₃) | | — | 0.14 | 0.14 | 0.14 | 0.14 | 0.14 |
| Y₂O₃/Ln₂O₃ | | — | 0.07 | 0.08 | 0.13 | 0.01 | 0.13 |
| Gd₂O₃/Ln₂O₃ | | — | 0.12 | 0.12 | 0.12 | 0.12 | 0.12 |
| (TiO₂ + B₂O₃)/Nb₂O₅ + WO₃) | | — | 11.6 | 11.6 | 11.6 | 12.0 | 12.6 |
| B₂O₃ + La₂O₃ + ZnO | | % by | 46.5 | 44.6 | 43.5 | 49.7 | 48.2 |
| | | mole | | | | | |
| SiO₂ + Y₂O₃ + ZnO₂ | | % by | 18.2 | 18.5 | 19.8 | 12.9 | 14.8 |
| | | mole | | | | | |
| (B₂O₃ + La₂O₃ + ZnO) − | | % by | 28.3 | 26.1 | 23.7 | 36.8 | 33.4 |
| (SiO₂ + Y₂O₃ + ZnO₂) | | mole | | | | | |
| Ti⁴⁺/Nb⁵⁺ | | — | 3.2 | 3.2 | 3.2 | 3.1 | 3.2 |
| Si⁴⁺ + B³⁺ | | % by | 35.2 | 35.2 | 35.0 | 37.3 | 36.5 |
| | | cation | | | | | |
| Solubility | | | | | | | |
| Melting Temperature | | | | | | | |
| 1270° C. | Number of | per cm³ | 0.11 | 0.14 | 0.13 | 0.02 | 0.04 |
| | Defects | | | | | | |
| | (Bubbles, | | | | | | |
| | Foreign | | | | | | |
| | Substances) | | | | | | |
| | External | % | 77.4 | 77.2 | 77.0 | 77.4 | 77.1 |
| | Transmittance | | | | | | |
| | @450 nm | | | | | | |
| 1300° C. | Number of | per cm³ | 0.04 | 0.05 | 0.06 | 0.00 | 0.00 |
| | Defects | | | | | | |
| | (Bubbles, | | | | | | |
| | Foreign | | | | | | |
| | Substances | | | | | | |
| | External | % | 76.6 | 76.7 | 76.5 | 76.7 | 77.0 |
| | Transmittance | | | | | | |
| | @450 nm | | | | | | |
| 1330° C. | Number of | per cm³ | 0.00 | 0.00 | 0.00 | 0.00 | 0.00 |
| | Defects | | | | | | |
| | (Bubbles, | | | | | | |
| | Foreign | | | | | | |
| | Substances) | | | | | | |
| | External | % | 76.5 | 76.1 | 76.2 | 76.5 | 76.1 |
| | Transmittance | | | | | | |
| | @450 nm | | | | | | |
| Basicity | | — | 13.0 | 13.0 | 13.0 | 12.3 | 12.3 |
| Water Resistance/Acid | | class/ | 1/1 | 1/1 | 1/1 | 1/1 | 1/1 |
| Resistance | | class | | | | | |
| Refractive Index (nd) | | — | 2.011 | 2.005 | 2.003 | 2.001 | 2.001 |
| Abbe's Number (νd) | | — | 29.1 | 29.0 | 29.0 | 28.9 | 28.9 |
| Density | | g/cm³ | 5.13 | 5.05 | 5.03 | 5.01 | 5.02 |
| Internal | Before | % | 96 | 95 | 96 | 94 | 93 |
| Transmittance | Thermal | | | | | | |
| @450 nm | Treatment | | | | | | |
| | After | % | 96 | 95 | 96 | 95 | 96 |
| | Thermal | | | | | | |
| | Treatment | | | | | | |
| | Amount of | % | 0 | 0 | 0 | 1 | 3 |
| | Change | | | | | | |

| | | | | | | |
|---|---|---|---|---|---|---|
| Pt Content | ppm | 6.5 | 4.5 | 7.7 | 2.4 | 5.5 |
| Rh Content | ppm | 0.05 | 0.07 | 0.09 | <0.01 | 0.03 |
| Fe₂O₃ Content | ppm | <0.5 | <0.5 | <0.5 | <0.5 | <0.5 |

A batch obtained by formulating raw materials to give each composition shown in Tables 2 to 8 was loaded into a platinum crucible and melted at 1350° C. for two hours. The molten glass was poured onto a carbon plate to form it into a shape, held at 700 to 800° C. for an hour, and then subjected to annealing treatment by decreasing the temperature to room temperature at a rate of −1° C./min, thus obtaining a glass sample. The obtained glass samples were measured in terms of water resistance, acid resistance, liquidus temperature, liquidus viscosity, refractive index, Abbe's number, density, glass transition point, coefficient of thermal expansion, and internal transmittance. The results are shown in Tables 2 to 8.

The water resistance and acid resistance were measured based on the powder method defined in JOGIS.

The liquidus temperature and liquidus viscosity were measured in the following manner.

The glass sample was remelted in an electric furnace under conditions at 1200° C. for 0.5 hours, held for 18 hours in the electric furnace having a temperature gradient, then taken out of the electric furnace, cooled in air, and measured in terms of liquidus temperature by determining a location where devitrified matter was precipitated with an optical microscope.

Separately, the glass sample was loaded into an aluminum crucible and remelted by heating. The obtained glass melt was determined in terms of glass viscosity at a plurality of temperatures by the platinum ball pulling-up method. Subsequently, using the measured values of glass viscosity, the constant of the Vogel-Fulcher equation was calculated and a viscosity curve was created. Using the obtained viscosity curve and the liquidus temperatures determined as above, the viscosities (liquidus viscosities) corresponding to the liquidus temperatures were determined.

The refractive index is indicated by a value measured for the d-line (587.6 nm) of a helium lamp. The Abbe's number was calculated using the refractive index at the d-line and the respective refractive indices at the F-line (486.1 nm) and C-line (656.3 nm) of a hydrogen lamp and in accordance with the formula: Abbe's number (νd)=[(nd−1)/(nF−nC].

The density was measured by the Archimedes' method using a glass sample weighing approximately 10 g.

The glass transition point was determined, in a thermal expansion coefficient curve measured by a dilatometer, from an intersection point between the line on a low-temperature side and the line on a high-temperature side.

The coefficient of thermal expansion was measured, using a glass sample formed into a columnar shape with a diameter of 5 mm and a length of 20 mm, in a temperature range of 30 to 300° C. with a dilatometer.

The internal transmittance was measured in the following manner. Each of an optically polished glass sample with a thickness of 10 mm±0.1 mm and an optically polished glass sample with a thickness of 5 mm±0.1 mm was measured in terms of light transmittance (linear transmittance) inclusive of surface reflectance loss at 0.5-nm intervals using a spectro-photometer (UV-3100 manufactured by Shimadzu Corporation). The internal transmittance τ₁₀ of the glass sample at a thickness of 10 mm was calculated from the formula below based on the obtained measured values.

log τ₁₀=−{(log T₅−log T₁₀)/Δd}×10(%)

T₅: light transmittance of glass sample with a thickness of 5 mm±0.1 mm

T₁₀: light transmittance of glass sample with a thickness of 10 mm±0.1 mm

Δd: thickness difference between both the glass samples

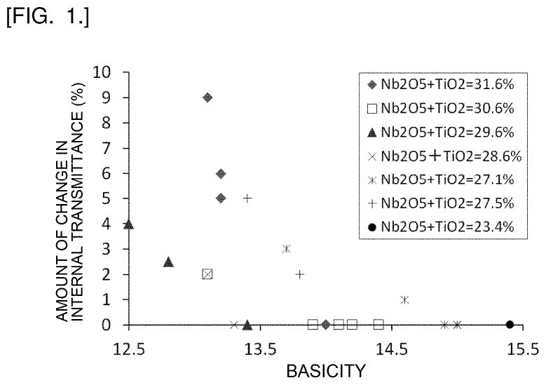

Also as for each of glass samples when subjected to thermal treatment at 700 to 800° C. for 72 hours and then decreasing the temperature to room temperature at a rate of −1° C./min, the internal transmittance was measured in the same manner. The values of the internal transmittances before and after the thermal treatment and the amount of change in internal transmittance between before and after the thermal treatment are shown in Tables 2 to 8. Furthermore, as for Nos. 1-1 to 1-5, Nos. 2-1 to 2-5, Nos. 3-1 to 3-3, Nos. 4-1 to 4-2, Nos. 5-1 to 5-5, Nos. 6-1 to 6-2, and No. 7-1, a graph on which the relationship between the basicity and the amount of change in internal transmittance is plotted is shown in FIG. 1. In FIG. 1, the compositions equal in the total content of TiO₂ and Nb₂O₅ are shown by the same plot.

As for Nos. 8-1 to 8-17, the solubilities and external transmittances at different melting temperatures were evaluated or measured.

The solubility was measured in the following manner. A batch obtained by formulating raw materials to give each composition shown in Tables 6 to 8 was loaded into a platinum crucible and melted at 1270° C. to 1330° C. for 90 minutes. The molten glass was poured onto a carbon plate to form it into a shape, held at 700 to 800° C. for an hour, then subjected to annealing treatment by decreasing the temperature to room temperature at a rate of −1° C./min, and then cut into a glass sample with 10 mm by 50 mm by 100 mm. The number of bubbles and foreign substances present in the interior of the obtained glass sample was counted by 50× microscopic observation and the number thereof per cm³ was calculated.

The external transmittance was measured in the following manner. The obtained glass sample was optically polished to have a thickness of 10 mm and measured in terms of light transmittance (linear transmittance) inclusive of surface reflectance loss at a wavelength of 450 nm using a spectro-photometer (UV-3100 manufactured by Shimadzu Corporation).

Furthermore, the glass samples were measured in terms of water resistance, acid resistance, refractive index, Abbe's number, density, and internal transmittance in the above-described manners. In addition, they were measured in terms of the respective contents of Pt, Rh, and Fe₂O₃. As for the respective contents of Pt and Rh, each glass sample crushed was decomposed in a mixed acid containing HF, HClO₄, HNO₃, and HCl and then measured with an ICP mass spectrometer. As for the content of Fe₂O₃, each glass sample crushed was decomposed in a mixed acid containing HF, H₂SO₄, HNO₃, and HCl and then measured with an ICP mass spectrometer. The evaluation of these properties was conducted using glass samples obtained by melting at 1270° C. for Nos. 8-8 to 8-10 and 8-16 to 8-17, glass samples obtained by melting at 1300° C. for Nos. 8-1, 8-3 to 8-7, and 8-11 to 8-15, and a glass sample obtained by melting at 1330° C. for No. 8-2.

As shown in Tables 2 to 8 and FIG. 1, the glass samples in examples exhibited a basicity as high as 12.1 to 15.4 and their difference in internal transmittance between before and after the thermal treatment at a wavelength of 450 nm was 0 to 9%. It can be seen from this that the glass samples in examples had an excellent light transmittance in the visible range without the need to undergo prolonged thermal treatment.

As shown in Tables 6 to 8, as the melting temperature is higher, internal defects including bubbles and foreign substances are less produced, but the external transmittance tends to be lower. On the contrary, as the melting temperature is lower, the external transmittance increases, but internal defects tend to be more produced. However, it can be seen that even when the melting temperature is low, the production of internal defects can be reduced by increasing (B₂O₃+La₂O₃+ZnO)—(SiO₂+Y₂O₃+ZrO₂).

### INDUSTRIAL APPLICABILITY

The optical glass according to the present invention is suitable as a light guide plate for use in a wearable image display device selected from among projector-equipped eyeglasses, an eyeglass- or goggle-mounted display, a virtual reality (VR) or augmented reality (AR) display device, and a virtual image display device.

1: An optical glass containing TiO₂ and Nb₂O₅ in a total amount of 20% by mole or more as components of a glass composition and having a basicity of 12 or more.

2: The optical glass according to claim 1, containing, in terms of % by mole, 8 to less than 40% TiO₂ and 1 to 11% Nb₂O₅.

3: The optical glass according to claim 1, having a refractive index nd of 1.8 to 2.3.

4: The optical glass according to claim 1, having an Abbe's number (νd) of 20 to 35.

5: The optical glass according to claim 1, having, with a thickness of 10 mm, an internal transmittance of 80% or more at a wavelength of 450 nm.

6: The optical glass according to claim 1, further containing, in terms of % by mole, 10 to 30% B₂O₃, 3% or more SiO₂, 0 to 5% RO (where R represents at least one selected from Mg, Ca, Sr, and Ba), 0 to 5% Ta₂O₅, 10 to 50% Ln₂O₃ (where Ln represents at least one selected from La, Gd, Y, and Yb), 0 to 1% ZnO, 0 to 1% Al₂O₃, and 0 to 0.2% WO₃.

7: The optical glass according to claim 1, wherein when the optical glass is thermally treated in a range of plus or minus 200° C. from a glass transition point for 72 hours, an amount of change in internal transmittance of the optical glass with a thickness of 10 mm at a wavelength of 450 nm is less than 10%.

8: An optical glass containing TiO₂ and Nb₂O₅ in a total amount of 20% by mole or more and 10 to 40% (B₂O₃+La₂O₃+ZnO)—(SiO₂+Y₂O₃+ZrO₂) as components of a glass composition, wherein a number of bubbles and foreign substances present in an interior of the optical glass is one or less per cm³.

9: An optical glass plate made of the optical glass according to claim 1.

10: The optical glass plate according to claim 9, having a thickness of 0.01 to 5 mm.

11: A light guide plate formed of the optical glass plate according to claim 9.

12: The light guide plate according to claim 11, being used in a wearable image display device selected from among projector-equipped eyeglasses, an eyeglass- or goggle-mounted display, a virtual reality (VR) or augmented reality (AR) display device, and a virtual image display device.

13: A wearable image display device comprising the light guide plate according to claim 11.

14: A method for producing the optical glass according to claim 1, the method comprising the step of melting a raw material to obtain molten glass and then cooling the molten glass to obtain a molded body, the method avoiding subjecting the molded body to thermal treatment in a range of plus or minus 200° C. from a glass transition point of the molded body for 48 hours or more.

15: The method for producing the optical glass according to claim 14, wherein a temperature during the melting of the raw material is 1400° C. or lower.
